(19) United States
(12) Patent Application Publication
(10) Pub. No.: US 2026/0365886 A1
(43) Pub. Date: Nov. 19, 2026

(54) THERMALLY EXPANDABLE SHEET, METHOD FOR PRODUCING THE SHEET, AND ARTICLE PROVIDED WITH THE SHEET

(71) Applicant: NIKKAN INDUSTRIES CO., LTD., Tokyo (JP)

(72) Inventor: Masahiro ISHIZAWA, Saitama (JP)

(73) Assignee: NIKKAN INDUSTRIES CO., LTD., Tokyo (JP)

(21) Appl. No.: 19/723,704

(22) Filed: Jun. 29, 2026

Related U.S. Application Data
(63) Continuation of application No. PCT/JP2026/009846, filed on Mar. 13, 2026.

(30) Foreign Application Priority Data
May 13, 2025 (JP) 2025-080748

(51) Int. Cl. C09J 7/35; H02K 3/30

(52) U.S. Cl. CPC C09J 7/35; H02K 3/30; C09J 2301/124; C09J 2301/304; C09J 2301/408; C09J 2463/00

(57) ABSTRACT

The present invention relates to a thermally expandable sheet used for adhering multiple adherends to each other, wherein the levels of Gurley stiffness in the first and second directions which are two different directions parallel to the planar direction of the sheet, differ from each other. Furthermore, the present invention relates to a method for producing the sheet and an article provided with the sheet. The present invention can provide a thermally expandable sheet capable of exhibiting sufficiently high insertability even when inserting into a gap formed by multiple adherends after a bending process.

### TECHNICAL FIELD

The present invention relates to a thermally expandable sheet, a method of producing the sheet, and an article provided with the sheet.

### CROSS REFERENCE TO RELATED APPLICATIONS

This application claims priority to Japan Patent Application No. 2025-080748, filed on May 13, 2025, the entire contents of which are incorporated herein by reference.

### BACKGROUND ART

Regarding thermally expandable sheets for adhering multiple adherends together, where they are placed between the adherends and the adhesive layers on their surfaces expand upon heating, there is a need to further improve their insertability when inserting the sheets into gaps formed by the adherends.

Therefore, to enhance the insertability of thermally expandable sheets, it has been considered to strengthen the stiffness of thermally expandable sheets by incorporating fillers into the adhesive layers, as shown in Patent Literatures 1 and 2, for example. The term “stiffness” as used herein refers to a property wherein a thermally expandable sheet is hardly bent or wrinkled, for example, due to friction with surfaces of the adherends and the like, when inserting the thermally expandable sheet into the gap between the adherends; for example, it refers to rigidity.
Patent Literature 1: WO 2023/176958
Patent Literature 2: JP B 7064636

The entire descriptions of Patent Literatures 1 and 2 are incorporated herein by reference.

### SUMMARY OF INVENTION

### Technical Problem

However, according to the inventor's intensive investigations to provide thermally expandable sheets with good workability, if fillers are merely incorporated into adhesive layers of thermally expandable sheets, as described in the aforementioned Patent Literatures 1 and 2, the stiffness of thermally expandable sheet becomes strong in all directions along its planar direction. Therefore, it has been found that when thermally expandable sheets are inserted into gaps formed by multiple adherends while fitting them into the shapes of these gaps, for example in a state where they are bent into U-shapes, the insertability may conversely decrease because thermally expandable sheets become difficult to bend or because the shape retention after a bending process becomes insufficient. Furthermore, if thermally expandable sheets have high stiffness, it is possible to bend them by applying higher pressure; however, there is a risk that this bending process may cause thermally expandable sheets to be scraped or broken, resulting in a deterioration of their properties. Note that the planar direction refers to directions along a surface of a thermally expandable sheet that is to be in contact with the adherend, which are perpendicular to the thickness direction of the thermally expandable sheet.

The present invention was made in view of the aforementioned problems, and the main objective of the present invention is to provide a thermally expandable sheet capable of exhibiting sufficiently high insertability even when inserting the thermally expandable sheet into a gap formed by multiple adherends after a bending process.

### Solution to Problem

In an aspect, the thermally expandable sheet according to the present invention is as follows.
[1] A thermally expandable sheet for adhering multiple adherends together through thermal expansion, where it is placed between the adherends, wherein the thermally expandable sheet prior to thermal expansion has different levels of Gurley stiffness in a first direction and a second direction, which are two different directions along the planar direction of the thermally expandable sheet.
[2] The thermally expandable sheet according to [1], wherein the first direction is MD direction, which is the longitudinal direction, and the second direction is TD direction, which is perpendicular to the first direction, and wherein the Gurley stiffness in the first direction is larger than the Gurley stiffness in the second direction in the thermally expandable sheet prior to thermal expansion.
[3] The thermally expandable sheet according to [1] or [2], wherein the thermally expandable sheet comprises at least filler with a scale-like, plate-like, needle-like, fibrous, or branched shape, and wherein the thermally expandable sheet prior to thermal expansion has an average of orientation degree, which is an angle between the long axis direction of the filler and the first direction, as observed by SEM in the thickness direction of the thermally expandable sheet, of 400 or less.
[4] The thermally expandable sheet according to [3], wherein, in the thermally expandable sheet prior to thermal expansion, the percentage in the filler of fillers having an orientation degree of less than 450 is 55% or more.
[5] The thermally expandable sheet according to [3] or [4], wherein the filler comprises a filler having an aspect ratio of 1.5 or more and 80 or less.
[6] The thermally expandable sheet according to any one of [3] to [5], wherein the thermally expandable sheet comprises a substrate and an adhesive layer on at least one surface of the substrate, and the adhesive layer comprises at least the filler, an epoxy resin, a curing agent, a foaming agent, and an elastomer.
[7] The thermally expandable sheet according to [6], wherein the content of the filler is 5 mass % or more and less than 80 mass % relative to 100 mass % of the adhesive layer.
[8] The thermally expandable sheet according to [6] or [7], wherein the epoxy resin comprises an epoxy resin having a softening point of 60 °C or more.
[9] The thermally expandable sheet according to any one of [6] to [8], wherein the epoxy resin comprises an epoxy resin having an epoxy equivalent of less than 300.
[10] The thermally expandable sheet according to any one of [6] to [9], wherein the adhesive layer comprises two or more epoxy resins, and at least one epoxy resin has a molecular weight of 10,000 or more.
[11] The thermally expandable sheet according to any one of [6] to [10], wherein the elastomer comprises an elastomer having a glass transition temperature (Tg) of 100 °C or more.
[12] The thermally expandable sheet according to any one of [6] to [11], wherein the elastomer comprises an elastomer having a molecular weight of 100,000 or more.
[13] The thermally expandable sheet according to any one of [1] to [12], wherein when the Gurley stiffness in the first direction is larger than the Gurley stiffness in the second direction in the thermally expandable sheet prior to thermal expansion, the thermally expandable sheet prior to thermal expansion has a shape retention in TD direction higher than a shape retention in MD direction.
[14] The thermally expandable sheet according to any one of [1] to [13], having a coefficient of dynamic friction on its surface prior to thermal expansion of 0.6 or less.
[15] The thermally expandable sheet according to any one of [1] to [14], having a shear adhesive force after thermal expansion and curing of 0.8 MPa or more at 23 °C and 0.1 MPa or more when heated to 200 °C.
[16] The thermally expandable sheet according to any one of [1] to [15], having a shear adhesive force of 0.1 MPa or more when heated to 200 °C, after thermal expansion and curing and further treatment for 500 hours under an environment of 200 °C.
[17] The thermally expandable sheet according to any one of [1] to [16], having a shear adhesive force of 0.1 MPa or more when heated to 200 °C, after thermal expansion and curing, and further treatment for 1000 hours under an environment of 85 °C and 85% RH.
[18] A method for producing thermally expandable sheet, which is produced through a step of coating a resin composition comprising an epoxy resin, a curing agent, a foaming agent, a filler, an elastomer, and a solvent, onto a substrate, wherein the step of coating the resin composition onto the substrate is performed while applying a shear stress in a certain direction.
[19] The method for producing thermally expandable sheet according to [18], wherein the resin composition comprises 20 mass % to 80 mass % of the solvent relative to 100 mass % of the resin composition.
[20] An article provided with the thermally expandable sheet according to any one of [1] to [17].

In another aspect, the thermally expandable sheet according to the present invention is as follows.

[1]

A thermally expandable sheet for adhering multiple adherends together through thermal expansion, where it is placed between the adherends, wherein
the thermally expandable sheet comprises a substrate having a thickness of 1 to 200 μm and an adhesive layer having a thickness of 10 to 200 μm laminated onto at least one surface of the substrate,
the adhesive layer comprises a filler, an epoxy resin, and a curing agent, and
the thermally expandable sheet has a ratio of a Gurley stiffness in MD direction of the thermally expandable sheet to a Gurley stiffness in TD direction of the thermally expandable sheet (MD direction/TD direction) of 1.1 or more.
   [2]

A thermally expandable sheet for adhering multiple adherends together through thermal expansion, where it is placed between the adherends, wherein
the thermally expandable sheet comprises a substrate having a thickness of 1 to 200 μm and an adhesive layer having a thickness of 10 to 200 μm laminated onto at least one surface of the substrate,
the adhesive layer comprises a filler, an epoxy resin, and a curing agent,
the filler comprises a filler with a scale-like, plate-like, needle-like, fibrous, or branched shape, and
the thermally expandable sheet prior to thermal expansion has an average of orientation degree of the filler of 40° or less:
wherein the orientation degree of the filler for the thermally expandable sheet prior to thermal expansion is defined as an angle between the long axis direction of the filler and MD direction of the thermally expandable sheet, as observed by SEM in the thickness direction of the thermally expandable sheet.
   [3]

A thermally expandable sheet for adhering multiple adherends together through thermal expansion, where it is placed between the adherends, wherein the thermally expandable sheet comprises a substrate having a thickness of 1 to 200 μm and an adhesive layer having a thickness of 10 to 200 μm laminated onto at least one surface of the substrate,
the adhesive layer comprises a filler, an epoxy resin, and a curing agent,
the filler comprises a filler with a scale-like, plate-like, needle-like, fibrous, or branched shape, and
the thermally expandable sheet prior to thermal expansion has a percentage in total filler of fillers having an orientation degree of less than 450 of 55% or more:
wherein the orientation degree of the filler for the thermally expandable sheet prior to thermal expansion is defined as an angle between the long axis direction of the filler and MD direction of the thermally expandable sheet, as observed by SEM in the thickness direction of the thermally expandable sheet.
   [4]

A thermally expandable sheet for adhering multiple adherends together through thermal expansion, where it is placed between the adherends, wherein
the thermally expandable sheet comprises a substrate having a thickness of 1 to 200 μm and an adhesive layer having a thickness of 10 to 200 μm laminated onto at least one surface of the substrate,
the adhesive layer comprises a filler, an epoxy resin, a curing agent, and an elastomer,
the elastomer comprises an elastomer having a glass transition temperature (Tg) of 100 °C or more, and
the thermally expandable sheet prior to thermal expansion has a Gurley stiffness in MD direction of the thermally expandable sheet larger than a Gurley stiffness in TD direction of the thermally expandable sheet.
   [5]

The thermally expandable sheet according to any one of [1] to [4], wherein the adhesive layer is an adhesive layer formed by coating a resin composition comprising components that constitute the adhesive layer and a solvent, onto a substrate at a coating rate of 50 to 200 mm/sec and then removing the solvent.

[6]

The thermally expandable sheet according to any one of [1] to [5], wherein the adhesive layer is an adhesive layer formed by using a resin composition comprising components that constitute the adhesive layer and a solvent and having a solid content concentration of 25 to 75%.

[17]

The thermally expandable sheet according to any one of [1] to [6], wherein a Gurley stiffness in MD direction of the thermally expandable sheet is 53.5 mgf or more.

[8]

The thermally expandable sheet according to any one of [1] to [7], wherein the substrate includes a metal film, a resin film, or a nonwoven fabric.

[9]

The thermally expandable sheet according to any one of [1] to [8], wherein the filler comprises a filler having an aspect ratio of 1.5 or more and 80 or less.

[10]

The thermally expandable sheet according to any one of [1] to [9], wherein the content of the filler is 5 mass % or more and less than 80 mass % relative to 100 mass % of the adhesive layer.

[11]

The thermally expandable sheet according to any one of [1] to [10], wherein the epoxy resin comprises an epoxy resin having a softening point of 60 °C or more.

[12]

The thermally expandable sheet according to any one of [1] to [11], wherein the epoxy resin comprises an epoxy resin having an epoxy equivalent of less than 300.

[13]

The thermally expandable sheet according to any one of [1] to [12], wherein the adhesive layer comprises two or more epoxy resins, and at least one epoxy resin has a molecular weight of 10,000 or more.

[14]

The thermally expandable sheet according to [4], wherein the elastomer comprises an elastomer having a molecular weight of 100,000 or more.

[15]

The thermally expandable sheet according to any one of [1] to [14], wherein the thermally expandable sheet prior to thermal expansion has a shape retention in TD direction higher than a shape retention in MD direction.

[16]

The thermally expandable sheet according to any one of [1] to [15], having a coefficient of dynamic friction on its surface prior to thermal expansion of 0.6 or less.

[17]

The thermally expandable sheet according to any one of [1] to [16], having a shear adhesive force after thermal expansion and curing of 0.8 MPa or more at 23 °C and 0.1 MPa or more when heated to 200 °C.

[18]

An article provided with the thermally expandable sheet according to any one of [1] to [17].

[19]

The article according to [18], wherein the article is a motor.

### Advantageous Effect of Invention

The present invention is highly innovative, based on the novel concept of varying the Gurley stiffness between the first and second directions of the thermally expandable sheet. According to the present invention, for example, the Gurley stiffness is high in the first direction (i.e., high rigidity) thereby enabling high insertability, while in the second direction, the Gurley stiffness is low, making it easier to perform bending processes, in this way, the present invention can provide a thermally expandable sheet capable of balancing stiffness in the insertion direction and shape retention in the bending direction of the thermally expandable sheet.

### BRIEF DESCRIPTION OF DRAWINGS

FIG. 1 is a schematic cross-sectional view showing the configuration of thermally expandable sheet 1 according to one embodiment of the present invention.

FIG. 2 is a schematic cross-sectional view showing the configuration of thermally expandable sheet 1 according to another embodiment of the present invention.

FIG. 3 is a graph showing results of shear stress measurements taken during formation of adhesive layers of thermally expandable sheets according to Examples of the present invention.

FIG. 4 is an explanatory diagram with respect to an evaluation method for thermally expandable sheets according to Examples of the present invention.

### EMBODIMENTS OF INVENTION

The following describes a basic configuration of thermally expandable sheet 1 according to one embodiment of the present invention.

### <Basic Configuration of Thermally Expandable Sheet>

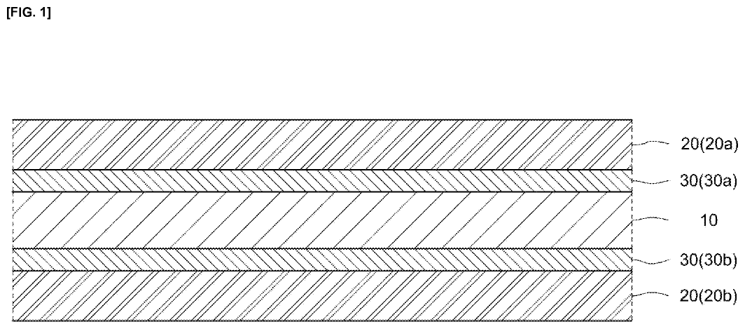

FIG. 1 is a schematic cross-sectional view showing the configuration of thermally expandable sheet 1 according to the present embodiment.

The thermally expandable sheet 1 of this embodiment is a thermally expandable sheet used for adhering multiple adherends together by being placed between the multiple adherends and heated to a high temperature, for example, 120 °C or more and 250 °C or less, to expand. The thermally expandable sheet 1 has a thickness of 10 μm or more and 1000 μm or less in a state prior to thermal expansion.

The thermally expandable sheet 1 of the present embodiment comprises, for example as shown in FIG. 1, a substrate 10, adhesive layers 20 formed on both surfaces of the substrate 10, and primer layers 30 positioned between the substrate 10 and the adhesive layers 20. The adhesive layer 20 and the primer layer 30 may be formed only on one side of the substrate 10.

### <<Substrate>>

The substrate 10 functions as a support material for supporting the adhesive layer 20.

Specifically, the substrate 10 is preferably in the form of a sheet, and may have a single-layer structure or a laminated structure. Furthermore, the substrate 10 may or may not have a porous structure inside.

The thickness of the substrate 10 is, for example, preferably 1 μm or more and 200 μm or less, more preferably 10 μm or more and 150 μm or less, and particularly preferably 25 μm or more and 100 μm or less. For example, when using the thermally expandable sheet 1 of the present embodiment by inserting it into a motor slot, providing the substrate 10 with a certain thickness can prevent the thermally expandable sheet 1 from buckling during the insertion into the motor slot. Keeping the thickness of substrate 10 from becoming too thick allows the sheet to be bent more easily. For these reasons as well, the thickness of the substrate 10 is preferably within the above-described range.

The material of the substrate 10 is not particularly limited, and may be an organic material or an inorganic material, or may be a resin film or a nonwoven fabric. For example, a metal film can be used when electrical conductivity is required for the thermally expandable sheet 1, and a resin film can be used when electrical insulation is required for the thermally expandable sheet 1.

The metal film is not particularly limited, and for example, copper foil and aluminum foil can be used. The thickness of the metal film is, for example, 1 μm or more and 100 μm or less, preferably 10 μm or more and 70 μm or less, and more preferably 15 μm or more and 50 μm or less. Furthermore, when the metal film is used as material for substrate 10, the thermal conductivity of the thermally expandable sheet 1 can be increased compared to a case where an organic material is used.

Examples of resin comprised in the resin film include polyester resins, such as polyethylene terephthalate (PET), polybutylene terephthalate, polyethylene naphthalate (PEN), and aromatic polyesters; polycarbonate; polyarylate; polyurethane; polyamide resins, such as polyamide and polyetheramide; polyimide resins, such as polyimide, polyetherimide, and polyamideimide; polysulfone resins, such as polysulfone and polyethersulfone; polyetherketone resins, such as polyetherketone and polyetheretherketone; polyphenylene sulfide (PPS); modified polyphenylene oxide and the like.

The glass transition temperature of the resin for the resin film is, for example, preferably 80 °C or more, or may be 140 °C or more, or 200 °C or more. Additionally, liquid crystal polymer (LCP) may be used as the resin.

Examples of the nonwoven fabric include, for example, nonwoven fabrics containing fibers, such as cellulose fibers, polyester fibers, nylon fibers, aramid fibers, polyphenylene sulfide fibers, liquid crystal polymer fibers, glass fibers, metal fibers, and carbon fibers, as well as mica paper.

In this embodiment, the substrate 10 preferably has electrical insulation and preferably contains polyimide (PI), polyethylene naphthalate (PEN), or polyphenylene sulfide (PPS). Polyimide, polyethylene naphthalate, and polyphenylene sulfide have high heat resistance and are suitable for cases where the thermally expandable sheet 1 is thermally expanded and cured by heating, or for use of the thermally expandable sheet 1 under high-temperature conditions. Additionally, polyimide, polyethylene naphthalate, and polyphenylene sulfide have high insulation and are preferred, for example, since the thermally expandable sheet 1 after heat curing can insulate the adherends from each other.

The substrate 10 may be a single-layer substrate, or a substrate consisting of a laminate having a layered structure in which components are adhered together with an adhesive agent for lamination. In applications where the thermal conductivity of the thermally expandable sheet is required, the substrate 10 is preferably the substrate consisting of a laminate having a laminated structure in which components are adhered together with an adhesive agent for lamination. The adhesive agent for lamination having high thermal conductivity can enhance the thermal conductivity of the substrate 10. Furthermore, the substrate 10 may comprise a filler. The substrate 10 comprising the filler can improve the thermal conductivity and electrical insulation of the thermally expandable sheet 1. Types of the filler are not particularly limited, and it may be the same type as, or a different type from, the filler contained in the adhesive layer or primer layer described below.

### <<Adhesive Layer>>

The adhesive layer 20 is a layer that expands upon heating to provide adhesive force, and in this embodiment, it is formed on both surfaces of the substrate 10 to form the outermost surface of the thermally expandable sheet 1. It is preferable that the adhesive layer 20 is located in the outermost layer of the thermally expandable sheet 1 since the outermost layer has a large influence on the stiffness of the entire thermally expandable sheet 1.

The adhesive layer 20 may be a continuous layer formed continuously or may be a discontinuous layer formed of a plurality of islands. Examples of the discontinuous layer include patterns of stripes, dots, and the like. Furthermore, the surface of the continuously formed adhesive layer 20 may have a concavo-convex shape, such as an embossed pattern.

The surface of the adhesive layer 20 may have sufficient tackiness to temporarily adhere to the adherend. However, when the thermally expandable sheet 1 is used by inserting it into a narrow gap, the adhesive layer 20 prior to thermal expansion is preferably non-tacky (tack-free).

For the thermally expandable sheet 1 of this embodiment, the outer surface of the adhesive layer 20 (i.e., the outermost surface of the thermally expandable sheet 1) prior to thermal expansion has a coefficient of dynamic friction of preferably 0.60 or less, more preferably 0.55 or less, and even more preferably 0.50 or less. By using the thermally expandable sheet 1 with a coefficient of dynamic friction of 0.60 or less on the outer surface of the adhesive layer 20 prior to thermal expansion, its slidability and insertability can be further improved, making the thermally expandable sheet 1 easy to insert into narrow gaps and highly user-friendly. For example, when adhering two adherends together by placing the thermally expandable sheet 1 between the two adherends, it is possible to smoothly insert the thermally expandable sheet 1 into a gap between these adherends, or to smoothly insert one of the adherends into a remaining gap after the thermally expandable sheet 1 has been placed in the other adherend. A specific example of this application includes manufacturing motors by adhering stator cores and coils. As described above, if the thermally expandable sheet has a coefficient of dynamic friction on the outer surface of the adhesive layer 20 of 0.60 or less, it can be inserted more smoothly into the slot of the stator core, and the coil can be inserted more smoothly into the even narrower gap where the thermally expandable sheet has been inserted. Furthermore, it is preferable that the coefficient of dynamic friction on the outer surface of the adhesive layer 20 prior to thermal expansion is 0.15 or more. By using the thermally expandable sheet 1 with a coefficient of dynamic friction of 0.15 or more on its outer surface, the sheet is less likely to fall off after being placed on the surface of the adherend or in the gap formed by multiple adherends until it is heated and expanded, thereby providing the thermally expandable sheet 1 with high workability. Furthermore, even when the coil is inserted into a narrow gap first and then the thermally expandable sheet is inserted, it is preferable that the coefficient of dynamic friction falls within the aforementioned range similarly.

Note that the coefficient of dynamic friction on the outer surface of the adhesive layer 20 can be measured by a sliding test in accordance with JIS K 7125, using the thermally expandable sheet 1 prior to thermal expansion and a SUS304 plate as a counter material with a measurement speed of 100 mm/min and a travel distance of 130 mm, wherein the plate is prepared by smoothing a surface to be contact with the outer surface of the thermally expandable sheet 1 via #800 buff polishing.

As for the thermally expandable sheet 1 of this embodiment, when adhesive layers 20 are provided on both surfaces of the substrate 10, it is sufficient for the coefficient of dynamic friction of the outer surface of at least one of the two adhesive layers 20 to fall within the aforementioned range. In particular, it is preferable that the coefficient of dynamic friction on the outer surfaces of both adhesive layers 20 falls within the above range.

The coefficient of dynamic friction on the outer surface of the thermally expandable sheet 1 can be adjusted to be lower, for example, by reducing a contact area with the adherend, such as by creating projections and depressions on the surface of the outermost layer. Furthermore, the coefficient of dynamic friction tends to be lower when a resin with a high elastic modulus is used for the outermost layer, so it is possible to adjust this property by varying the resin composition of the outermost layer.

The thickness of the adhesive layer 20 of the present embodiment is not particularly limited, and may be, for example, 10 μm or more and 20 μm or more. It is preferable for the thickness of the adhesive layer 20 to be 10 μm or more, since sufficient adhesive force can be obtained. On the other hand, the thickness of the adhesive layer 20 is preferably, for example, 200 μm or less. The total thickness of the adhesive layer 20 in the thermally expandable sheet 1 is preferably between 0.2 and 8 times, more preferably between 0.4 and 5 times the thickness of the substrate 10. By setting the range in this manner, it is possible to significantly increase an impact on the overall stiffness of the thermally expandable sheet 1, for example, when fillers are incorporated into the adhesive layer 20 and an orientation degree of the fillers is controlled as described below. The term “total thickness of the adhesive layer 20” as used herein refers to the total thickness of the adhesive layer comprised in a single thermally expandable sheet 1. Specifically, when the adhesive layer 10 is provided on one surface of the substrate 10, it refers to the thickness of the adhesive layer 20 itself, and when the adhesive layers 20 are provided on both surfaces of the substrate 10, it refers to the total thickness of the two adhesive layers 20 formed on both sides.

Specific examples of the adhesive layer 20 according to this embodiment include, for example, a composition comprising at least an epoxy resin, a curing agent, and a foaming agent, and further comprising a filler, an elastomer, a curing accelerator, and other additives as needed.

### <<<Epoxy Resin>>>

The adhesive layer 20 of this embodiment contains, for example, an epoxy resin, which is a thermosetting resin. The epoxy resin is not particularly limited as long as it is a resin containing an epoxy group. Examples of the epoxy resin include bisphenol A-type epoxy resins, bisphenol F-type epoxy resins, bisphenol S-type epoxy resins, hydantoin-type epoxy resins, biphenyl-type epoxy resins, alicyclic epoxy resins, triphenylmethane-type epoxy resins, phenol novolac-type epoxy resins, cresol novolac-type epoxy resins, naphthol novolac-type epoxy resins, dicyclopentadiene/phenol epoxy resins, alicyclic amine epoxy resins, aliphatic amine epoxy resins, and variously modified epoxy resins derived from these, copolymers of glycidyl methacrylate and other polymerizable unsaturated compounds, epoxy-modified polybutadiene, epoxy-modified silicone, etc. These may be used alone or in mixtures of multiple types. Additionally, thermosetting resins other than epoxy resin, such as phenolic resin, may be used for the adhesive layer 20.

The content of the epoxy resin in the adhesive layer 20 is, for example, 1 mass % or more, 10 mass % or more, or 25 mass % or more, relative to the total mass of the adhesive layer 20. By setting the content of the epoxy resin to 1 mass % or more, the thermally expandable sheet 1 exhibits excellent adhesive force and anti-blocking properties. On the other hand, the content of the epoxy resin is, for example, 90 mass % or less, and may be 80 mass % or less, or 70 mass % or less, relative to the total mass of the adhesive layer 20. By setting the content of the epoxy resin to 90 mass % or less, the thermally expandable sheet 1 can achieve a combination of anti-blocking properties, adhesive force, and crack resistance.

Furthermore, the epoxy resin has a melt viscosity at 150 °C of 0.005 Pa·s or more, and may be 0.03 Pa·s or more, or 0.1 Pa·s or more. By setting the melt viscosity of the epoxy resin to 0.005 Pa·s or more, not only excellent foaming property is obtained when the thermally expandable sheet 1 is heated and expanded, but also the tackiness of the adhesive layer 20 is suppressed, improving the insertability into the gap formed by the adherends when the adhesive layer 20 is provided on the outermost layer of the thermally expandable sheet 1, as in this embodiment. On the other hand, the melt viscosity at 150 °C is, for example, 10 Pa·s or less, and may be 5 Pa·s or less, or 2 Pa·s or less. By setting the melt viscosity of the epoxy resin to 10 Pa·s or less, the adhesive layer 20 exhibits high fluidity during thermal expansion, resulting in thermally expandable sheet 1 with excellent foaming property. Melt viscosity can be determined by measuring it using an instrument, such as the ARES-G2 manufactured by TA Instruments, under the following conditions: a heating rate of 50 °C/min, a temperature range of 23 °C to 220 °C (after reaching 220 °C, held for 10 minutes), the “shear” deformation mode, and a frequency of 1 Hz.

The epoxy resin has a softening point of preferably 60 °C or more, more preferably 70 °C or more, and even more preferably 80 °C or more. The use of epoxy resin with a softening point of 60 °C or more suppresses the occurrence of tackiness in thermally expandable sheet 1. By suppressing the tackiness of thermally expandable sheet 1, it is possible to prevent the adhesive layer 20 from sticking to adjacent surfaces when the product is stored or transported in a rolled state, or from sticking to the wall surfaces and making insertion difficult, for example, when it is inserted into the gap formed by the adherends. Furthermore, considering summer conditions and tropical regions, it is preferable that the tack does not activate even at 50 °C. On the other hand, the epoxy resin has a softening point of, for example, preferably 150 °C or less, more preferably 130 °C or less, and even more preferably 110 °C or less. By setting the softening point of the epoxy resin lower than the thermal expansion onset temperature of the foaming agent, the foaming agent can be expanded while the epoxy resin remains highly flexible, thereby ensuring uniform expansion of the adhesive layer 20. Additionally, lowering the softening point improves flowability during heating, thereby increasing reactivity and facilitating the attainment of superior adhesive force.

Note that the softening point of epoxy resin can be measured using the ring-and-ball type softening point test method specified in JIS K 2207.

Furthermore, the epoxy resin preferably has a minimum viscosity temperature at which its viscosity is lowest, within the temperature range extending from the thermal expansion onset temperature of the foaming agent contained in the adhesive layer 20 to the curing activation temperature during the curing behavior of the epoxy resin. The use of such an epoxy resin is preferable because, when the adhesive layer 20 is heated, the resin can be cured after the foaming agent has sufficiently expanded, thereby optimizing both the expansion rate and the adhesive force of the entire thermally expandable sheet 1.

The curing activation temperature in the curing behavior of epoxy resin can be determined, for example, as the temperature showing an exothermic peak based on the relationship between the temperature and the exothermic energy of the curing reaction, as measured using a differential scanning calorimeter (DSC).

The minimum viscosity temperature, at which the viscosity of the epoxy resin is the lowest, can be determined, for example, as the temperature at which the complex viscosity curve reaches an off-peak, based on the relationship between the temperature and melt viscosity (complex viscosity) of the resin sample as measured by a viscoelasticity measurement device.

The epoxy resin has an epoxy equivalent of, for example, preferably 5000 g/eq or less, more preferably 1000 g/eq or less, and even more preferably 300 g/eq or less. Reducing the epoxy equivalent increases the cross-linking density between the epoxy resin and the curing agent, which tends to enhance adhesive force. When an epoxy resin with a high softening point is used for the purpose of reducing tackiness, it is preferable to use an epoxy resin with a low epoxy equivalent to enhance adhesive force. On the other hand, the epoxy equivalent is, for example, 10 g/eq or more, and may be 50 g/eq or more, or 100 g/eq or more. By setting the epoxy equivalent to 10 g/eq or more, the reactivity can be suppressed, thereby preventing storage stability from deteriorating due to the reaction proceeding even during storage.

The epoxy equivalent herein refers to the weight of resin containing one equivalent of epoxy group, which can be measured by a method compliant with JIS K 7236.

The epoxy resin may be a monofunctional epoxy resin, a bifunctional epoxy resin, a trifunctional epoxy resin, or an epoxy resin having four or more functional groups. If epoxy resins with two or more functional groups are used, the cross-linking density between the epoxy resin and the curing agent increases, resulting in higher adhesive force.

### <<<Curing Agent>>>

As a curing agent for the adhesive layer 20, curing agents commonly used for epoxy resin-based adhesives may be employed. The curing agent is preferably solid at 23 °C. Curing agents that are solid at 23 °C can have longer storage stability (pot life) compared to curing agents that are liquid at 23 °C. The curing agent may also be a latent curing agent. The curing agent may be a curing agent that undergoes a curing reaction by heat, or a curing agent that undergoes a curing reaction by light. The curing agent may be used alone or in combination of two or more.

The reaction onset temperature of the curing agent is, for example, 110 °C or more, and may be 130 °C or more. By setting a higher reaction onset temperature, the epoxy resin in the adhesive layer 20 cures in a state of high flexibility and fluidity, allowing for uniform curing. On the other hand, the reaction onset temperature of the curing agent is, for example, 200 °C or less. By setting a lower reaction onset temperature, degradation of the resin components in the adhesive layer 20 can be prevented. Furthermore, when using resins with high heat resistance, such as phenolic resins, in addition to epoxy resins, the reaction onset temperature of the curing agent may be 300 °C or less, due to the reduced degradation of the resin components. The reaction onset temperature of the curing agent can be determined by differential scanning calorimetry (DSC).

Specific examples of the curing agent include imidazole-based curing agent, phenol-based curing agent, amine-based curing agent, acid anhydride-based curing agent, isocyanate-based curing agent, and thiol-based curing agent.

Examples of the imidazole-based curing agent include imidazole, 2-phenyl-4,5-dihydroxymethylimidazole, 2-phenyl-4-methyl-5-hydroxymethylimidazole, 2-methylimidazole, 2-ethylimidazole, 2-ethyl-4-methylimidazole, 2-isopropylimidazole, 2-phenylimidazole, as well as carboxylates of imidazole compounds and adducts with epoxy compounds. Additionally, the imidazole-based curing agent preferably has a hydroxyl group. Because crystallization occurs via hydrogen bonding between hydroxyl groups, the reaction onset temperature tends to increase.

Examples of the phenol-based curing agent include, for example, phenolic resin. Furthermore, examples of phenolic resin include, for example, resole-type phenolic resin and novolac-type phenolic resin. In terms of crack resistance and other factors, a phenol-type novolac resin with a glass transition temperature (Tg) of 110 °C or less is particularly preferred. The phenol-based curing agent and imidazole-based curing agent may also be used in combination. In such cases, it is preferable to use the imidazole-based curing agent as a curing catalyst.

Examples of the amine-based curing agent include aliphatic amine, such as diethylenetriamine (DETA), triethylenetetramine (TETA), and m-xylylene diamine (MXDA); aromatic amine, such as diaminodiphenylmethane (DDM), m-phenylenediamine (MPDA), and diaminodiphenylsulfone (DDS); alicyclic amine; polyamide amine; dicyandiamide-based curing agent, such as dicyandiamide (DICY); organic acid dihydrazide-based curing agent; amine adduct-based curing agent; and ketimine-based curing agent.

Examples of the acid anhydride-based curing agent include, for example, alicyclic acid anhydride (liquid acid anhydrides), such as hexahydro phthalic anhydride (HHPA), methyltetrahydro phthalic anhydride (MTHPA); and aromatic acid anhydride, such as trimellitic anhydride (TMA), pyromellitic dianhydride (PMDA), and benzophenone tetracarboxylic dianhydride (BTDA).

Examples of the isocyanate-based curing agent include, for example, block isocyanates.

Examples of the thiol-based curing agent include, for example, ester-bonding type thiol compound, aliphatic ether-bonding type thiol compound, and aromatic ether-bonding type thiol compound.

The content of the curing agent is theoretically determined such that the number of reactive functional groups of the curing agent relative to the number of epoxy groups of the epoxy resin is approximately 1:1. The ratio (equivalent ratio) of the number of reactive functional groups of the curing agent to the number of epoxy groups of the epoxy resin is usually 0.5 or more and 2.0 or less, preferably 0.8 or more and 1.2 or less.

The content of the curing agent is, for example, 1 mass % or more and 40 mass % or less relative to the total mass of the adhesive layer 20. For example, when using amine-based or imidazole-based curing agents as the main components of the curing agent, the content of the curing agent is preferably 1 mass % or more and 15 mass % or less, relative to the total mass of the adhesive layer 20. On the other hand, when the phenol-based curing agent is used as the main component of the curing agent, the content of the curing agent is preferably, for example, 5 mass % or more and 40 mass % or less relative to the total mass of the adhesive layer 20. Note that the use of the imidazole-based or phenol-based curing agents as the main component of the curing agent means that the mass percentage of the imidazole-based or phenol-based curing agents is the highest in the curing agent.

### <<<Foaming Agent>>>

As the foaming agent, foaming agents commonly used in foamable layers of foamable adhesive sheets can be employed. The foaming agent may be a foaming agent that undergoes a foaming reaction by heat, or a foaming agent that undergoes a foaming reaction by light.

The thermal expansion onset temperature of the foaming agent is preferably higher than the softening point of the epoxy resin and lower than the curing activation temperature of the epoxy resin. The thermal expansion onset temperature of the foaming agent is, for example, 70 °C or more, and may be 100 °C or more. By setting a higher thermal expansion onset temperature, foaming occurs in a state where the resin components in the adhesive layer 20 maintain high flexibility and flowability, thereby allowing the adhesive layer 20 to expand more uniformly. On the other hand, the thermal expansion onset temperature of the foaming agent is, for example, 210 °C or less. By setting the thermal expansion onset temperature to 210 °C or less, degradation of the resin components in the adhesive layer 20 can be more reliably prevented.

Examples of the foaming agent include organic foaming agent and inorganic foaming agent. Examples of the organic foaming agent include, for example, azo foaming agent, such as azodicarbonamide (ADCA), azobisformamide, and azobisisobutyronitrile; fluorinated alkane-based foaming agent, such as trichloromonofluoromethane; hydrazine-based foaming agent, such as p-toluenesulfonyl hydrazide; semicarbazide-based foaming agent, such as p-toluenesulfonyl semicarbazide; triazole-based foaming agent, such as 5-morpholyl-1,2,3,4-thiatriazole; and N-nitroso-based foaming agent, such as N,N-dinitrosoterephthalamide. On the other hand, examples of the inorganic foaming agent include ammonium carbonate, ammonium hydrogen carbonate, ammonium nitrite, ammonium borohydride, and azides.

Additionally, thermally expandable microcapsules may be used as the foaming agent. A thermally expandable microcapsule preferably has a core of a thermally expandable agent, such as a hydrocarbon, and a shell of a thermoplastic resin, such as an acrylonitrile copolymer, with a gas barrier property. When the thermally expandable microcapsules are heated, the thermoplastic resin of the shell softens, and the capsules expand due to the volume increase of the thermally expandable agent. For example, vaporization of a low boiling hydrocarbon-based compound can be used to expand the capsules. These foaming agents may be used alone or in combination of multiple types.

The content of the foaming agent and the volumetric expansion ratio can be appropriately determined according to strength and adhesive force required for the cured adhesive layer 20, the expansion ratio required for the thermally expandable sheet 1, and other factors. The content of the foaming agent is, for example, 0.5 mass % or more, and may be 2 mass % or more, relative to the total mass of the adhesive layer 20. On the other hand, the content of the foaming agent is, for example, 60 mass % or less, and may be 50 mass % or less, relative to the total mass of the adhesive layer 20.

The foaming ratio of the adhesive layer 20 is, for example, 1.5 times or more, and may be 3 times or more. On the other hand, the foaming ratio of the adhesive layer 20 is, for example, 20 times or less, and may be 15 times or less. The foaming ratio is calculated by heating the thermally expandable sheet 1 that is cut out in 50×50 mm, in a furnace set to 200 °C for 10 minutes to cause foaming and curing, and then using the following formula to compare the thicknesses before and after the process.

Foaming ratio={(Thickness of thermally expandable sheet 1 after heating)−(Thickness of substrate 10)}/{(Thickness of thermally expandable sheet 1 before heating)−(Thickness of substrate 10)}

### <<<Filler>>>

The adhesive layer 20 preferably further comprises a filler. The type of filler may be an inorganic filler or an organic filler. The type of filler are not limited, and examples include talc, mica, silica, alumina, kaolin, sericite, calcium carbonate, glass flakes, wollastonite, sepiolite, hydrotalcite, montmorillonite, PMF, gypsum fiber, potassium titanate, phosphate fiber, MOS, xonotlite, dawsonite, acicular calcium carbonate, glass fibers, carbon fibers, silicon carbide, silicon nitride, boron nitride, aluminum nitride, aluminum borate, zinc oxide, silicon oxide, titanium oxide, copper, nickel, magnesium oxide, aluminum oxide, calcium oxide, aluminum hydroxide, magnesium hydroxide, antimony trioxide, zinc borate, molybdenum compounds, titanium dioxide, and others.

The content of the filler is preferably 3 mass % or more and 90 mass % or less, more preferably 5 mass % or more and 80 mass % or less, and most preferably 8 mass % or more and 65 mass % or less, relative to the total mass of the adhesive layer 20. Increasing the filler content tends to result in thermally expandable sheet 1 with high stiffness, while reducing the filler content improves the wetting property of the adhesive layer 20 on the adherend, resulting in thermally expandable sheet 1 with excellent adhesive force. If the filler content can be reduced, there is no need to use epoxy resins with low softening points to improve adhesive force, thereby resulting in thermally expandable sheet 1 with balanced tackiness and adhesive force. By setting the filler content to 3 mass % or more and 90 mass % or less, the filler disperses more easily in the epoxy resin, thereby preventing filler precipitation and resulting in thermally expandable sheet 1 with higher stiffness.

Although the shape and aspect ratio of filler are not limited, incorporating a filler with a high aspect ratio into the adhesive layer 20 may improve the partial discharge inception voltage of the adhesive layer 20. By incorporating the filler with a high aspect ratio, particles of the filler are more likely to intertwine with each other, enabling the adhesive layer 20 to contain a large number of microvoids. By doing so, the electric charge accumulated in the adhesive layer 20 is discharged promptly, thereby preventing a large charge from building up within the thermally expandable sheet 1 and reducing damage caused by discharge.

Furthermore, the use of filler with high aspect ratio may improve the thermal conductivity of thermally expandable sheet 1 in the thickness direction. When seeking to improve the thermal conductivity of the sheet in the thickness direction, it is generally considered best to incorporate spherical fillers to create heat transfer pathways in the thickness direction. However, when using both the foaming agent and filler as in thermally expandable sheet 1, the use of the filler with a high aspect ratio allows the filler to penetrate the narrow spaces between the foaming agent particles after foaming, facilitating the creation of the heat transfer pathways in the thickness direction, which enables providing thermally expandable sheet 1 with excellent thermal conductivity.

### <<<Elastomer>>>

The adhesive layer 20 may further contain an elastomer. In this specification, the term “elastomer” refers broadly to a resin that, when incorporated into the adhesive layer 20, imparts to the adhesive layer 20 the toughness and flexibility necessary to prevent failure even when subjected to bending or twisting; it is not limited to materials generally available on the market as elastomer materials or rubber materials. Elastomers of this type may comprise, for example, at least one of polyester resin, polyvinyl acetal resin, butyral resin, urethane resin, acrylic resin, acrylic rubber, fluoro rubber, carboxyl-terminated butadiene nitrile rubber (CTBN), and epoxy-modified butadiene.

When the adhesive layer 20 contains an elastomer, the elastomer preferably has no carboxyl group or a small number of carboxyl functional groups, depending on its compatibility with the other materials used. By incorporating an elastomer with a low carboxyl group content, the reaction between the component in the foaming agent and the carboxyl groups in the resin composition prepared by blending the various materials contained in the adhesive layer 20 is prevented, thereby avoiding gelation and resulting in benefits, such as an improved appearance of the adhesive layer 20.

When the adhesive layer 20 contains the elastomer, the content of the elastomer is, for example, 0.5 mass % or more, and may be 1 mass % or more, and more preferably 2 mass % or more, relative to the total mass of the adhesive layer 20. On the other hand, when the adhesive layer 20 contains the elastomer, the content of the elastomer is 30 mass % or less and may be 20 mass % or less, and more preferably 15 mass % or less, relative to the total mass of the adhesive layer 20. By setting the content of the elastomer to 2 mass % or more, the flexibility and toughness of the adhesive layer 20 can be enhanced, thereby further improving the adhesion of the adhesive layer 20 to the substrate 10 and suppressing cracking of the adhesive layer 20. Furthermore, by limiting the content of the elastomer to 30 mass % or less, the complex melt viscosity of thermally expandable sheet 1 can be suppressed when the temperature reaches the thermal expansion onset temperature of the foaming agent contained in the sheet during thermal expansion, thereby allowing adhesive layer 20 to expand sufficiently. Additionally, by reducing the content of the elastomer, the adhesive force of the adhesive layer 20 can be increased, and therefore the use of epoxy resins with low softening points is not necessary for the purpose of improving adhesive force, allowing the thermally expandable sheet 1 to achieve a balance between tackiness and adhesive force.

When the adhesive layer 20 contains the elastomer, the elastomer preferably has a glass transition temperature (Tg) of, for example, 100 °C or more to 120 °C or less. By using the elastomer with Tg of 100 °C or more, the stiffness of thermally expandable sheet 1 can be further improved, or its tackiness can be further reduced. By using the elastomer with Tg of 120 °C or less, the adhesive layer 20 can be made less prone to cracking. If higher flexibility is desired for the adhesive layer 20, it is preferable to use a combination of the elastomer with Tg of 100 °C or more and an elastomer with Tg of less than 100 °C.

The glass transition temperature (Tg) of elastomers can be measured by thermomechanical analysis (TMA), differential scanning calorimetry (DSC), or dynamic mechanical analysis (DMA); for example, it can be measured by DSC in accordance with the method compliant with JIS K 7121.

### <<<Curing Accelerator>>>

The adhesive layer 20 may further contain a curing accelerator. As the curing accelerator, for example, an imidazole-based compound may be used. The imidazole-based compound has advantages in that it can be used as a singular catalyst and that it is available in very fine particle sizes, thereby making it easy to use, compared to other curing catalysts. Specific examples of the imidazole-based compound include imidazole derivatives, such as 2-phenyl-4,5-dihydroxymethylimidazole, 2-phenyl-4-methylimidazole, 2-ethyl-4-methylimidazole, 2,4-diethylimidazole, and 2-phenyl-4-methyl-5-hydroxyimidazole. Two or more imidazole-based compounds may be used in combination. In particular, 2-phenyl-4,5-dihydroxymethylimidazole is preferred. The content of the imidazole-based compound is preferably 0.1 mass % or more and 2.0 mass % or less, more preferably 0.5 mass % or more and 1.5 mass % or less, relative to the total mass of the adhesive layer 20.

### <<<Additives>>>

The adhesive layer 20 may, if necessary, comprise a silane coupling agent, an antioxidant, a light stabilizer, a UV absorber, a lubricant, a plasticizer, an antistatic agent, a crosslinking agent, and a colorant. Examples of the silicone coupling agent include epoxy-based silicone coupling agent. Examples of the antioxidant include a phenolic antioxidant and a sulfur-based antioxidant.

### <<Primer Layer>>

As shown in FIG. 1, the thermally expandable sheet 1 may further comprise a primer layer 30 between the substrate 10 and the adhesive layer 20 in order to improve the adhesion between the substrate 10 and the adhesive layer 20. In particular, when the adhesive layer 20 contains a filler or an epoxy resin with a high softening point, it is preferable to provide the primer layer 30 in order to enhance the adhesion between the adhesive layer 20 and the substrate 10 and to prevent delamination during bending processes or insertion into gaps.

The primer layer 30 may contain a resin. The resin included in the primer layer 30 is not limited as long as it is highly flexible resin, such as polyester, polyvinyl chloride, polyvinyl acetate, polyurethane, acrylic, or styrene. When the resin contained in the primer layer 30 has functional groups, the primer layer 30 can cross-link with the adhesive layer 20 present on its surface, thereby enhancing the adhesion between the primer layer 30 and the adhesive layer 20.

Furthermore, when the functional groups of the resin contained in the primer layer 30 react with the epoxy resin contained in the adhesive layer 20, it is preferable to set the number of reactive functional groups of the curing agent in the adhesive layer 20 to be less than a ratio of 1:1 relative to the number of epoxy groups of the epoxy resin. In this configuration, the epoxy resin in the adhesive layer 20 that is not consumed in the reaction with the curing agent in the adhesive layer 20 cross-links with the functional groups of the resin contained in the primer layer 30, thereby enhancing the adhesion between the adhesive layer 20 and the primer layer 30.

Furthermore, the primer layer 30 may contain a curing agent for curing the resin included in the primer layer. Examples of the curing agent used for curing the resin contained in the primer layer 30 include isocyanate-based curing agent.

The primer layer 30 may contain a filler. If the primer layer 30 contains a filler, the stiffness of the thermally expandable sheet 1 can be increased. The filler in the primer layer 30 is preferably selected under the same conditions as the filler in the adhesive layer 20.

The thickness of the primer layer 30 is not specifically limited, and is, for example, 0.1 μm or more and may be 0.2 μm or more, or 0.5 μm or more. By increasing the thickness of the primer layer 30, the cracking resistance can be improved. On the other hand, the thickness of the primer layer 30 is, for example, m or less. By setting the thickness of the primer layer to 10 μm or less, it is possible to prevent stress concentration in the primer layer and subsequent breakage when subjected to shear stress.

### <Characteristic Constitution of Thermally Expandable Sheet 1>

As a result of extensive studies by the present inventor, it has been found that a thermally expandable sheet with high stiffness may actually reduce insertability, because when such a sheet is bent to match the shape of a gap formed by multiple adherends and inserted into that gap to fill it upon thermal expansion of the sheet, the sheet becomes difficult to bend, or its shape retention after the bending process becomes insufficient. It has also been found that if the thermally expandable sheet has high stiffness, it is possible to bend it by applying higher pressure; however, there is a risk that the thermally expandable sheet may be scraped or broken, resulting in a deterioration of its properties.

Accordingly, the inventor discovered that it is possible to develop a thermally expandable sheet that is easy to bend and has high insertability by increasing the stiffness in the insertion direction, along which the sheet is inserted into the gap, and reducing the stiffness in the bending direction. Making the stiffnesses differ in two directions along the surface of the thermally expandable sheet represents a completely new and unprecedented approach.

Therefore, the thermally expandable sheet 1 of the present embodiment has different stiffnesses in the first and second directions, which are two different directions along the planar direction of the sheet, prior to thermal expansion.

The stiffness in each direction along the planar direction of the thermally expandable sheet 1 can be evaluated by measuring Gurley stiffness in each direction along the planar direction of the thermally expandable sheet 1, in accordance with JIS L 1085. Note that the planar direction, as mentioned above, refers to directions along a surface of a thermally expandable sheet that is to be in contact with the adherend, which are perpendicular to the thickness direction of the thermally expandable sheet. The direction in which the Gurley stiffness is high is defined as the first direction, and the direction in which the Gurley stiffness is low is defined as the second direction. It is preferable that the first and second directions are perpendicular to each other.

The Gurley stiffness in the first direction is preferably 20 mgf or more, and more preferably 30 mgf or more or 40 mgf or more, in terms of further improving the insertability of the thermally expanded sheet. The Gurley stiffness in the first direction is preferably 2000 mgf or less, more preferably 1800 mgf or less or 1600 mgf or less, and may be 1400 mgf or less, 1200 mgf or less, 1000 mgf or less, 800 mgf or less, 600 mgf or less, 400 mgf or less, or 200 mgf or less.

The Gurley stiffness in the second direction is preferably 1800 mgf or less, more preferably 1600 mgf or less or 1400 mgf or less, and may be 1200 mgf or less, 1000 mgf or less, 800 mgf or less, 600 mgf or less, 400 mgf or less, 200 mgf or less, or 100 mgf or less, in terms of further improving the bendability of the thermally expandable sheet. The Gurley stiffness in the second direction is preferably 15 mgf or more, more preferably 25 mgf or more, or 35 mgf or more.

The ratio of the Gurley stiffness in the first direction to the Gurley stiffness in the second direction (first direction/second direction) is preferably 1.1 or more, and more preferably 1.5 or more, or 2.0 or more, in terms of further improving the balance between the insertability and bendability of the thermally expandable sheet. The upper limit of the ratio for Gurley stiffness is not particularly limited, and is, for example, 5.0 or less, 4.0 or less, or 3.0 or less.

In motor manufacturing processes, the thermally expandable sheet is often supplied in a rolled form. As a result of extensive studies by the inventor, it has been found that, for example, when inserting and positioning the thermally expandable sheet into the narrow U-shaped gap formed by a coil and a stator core of a motor, manufacturing efficiency can be improved by using MD direction (the flow direction of the roll) of the sheet as an insertion direction, and the direction perpendicular to MD direction, i.e., TD direction, as a bending direction, and performing a bending process such that a crease is formed parallel to MD direction.

From these findings, it has been found that it is preferable to set MD direction and TD direction as the first and second directions, respectively, thereby increasing the stiffness in MD direction and reducing the stiffness in the TD direction, for obtaining a thermally expandable sheet with high insertability.

One way to obtain such thermally expandable sheet 1 is to increase the orientation degree of filler in the state prior to thermal expansion, thereby increasing the stiffness in the desired direction of the thermally expandable sheet 1 more than in other directions, even with a lower filler content, as compared with a case where the orientation degree is not controlled.

If the insertion direction and the bending direction are perpendicular to each other, as in the case where the motor and coil mentioned above are the adherends, and if it is desired to vary the stiffness in these two directions, it has been found that it is particularly advantageous to increase the orientation degree of the filler contained in the thermally expandable sheet. The orientation degree of the filler refers, for example, to the orientation degree of the long axis direction of the filler relative to MD direction.

By doing so, a physical resistance force acts along the long axis direction (also called an orientation direction) of the filler and against the force attempting to deform the thermally expandable sheet, allowing the stiffness of the thermally expandable sheet to be increased. Furthermore, in a direction perpendicular to the orientation direction of the filler, the force exerted by the filler is less likely to act in a direction opposite to the force exerted by the resin components contained in the thermally expandable sheet to maintain its shape after bending, thereby enhancing the shape retention of the thermally expandable sheet.

The inventor further found that another conventional problem is that incorporating a large amount of filler to increase the stiffness of the thermally expandable sheet may result in a decrease in adhesive force when the sheet is heated and expanded. It was considered that this problem could be also solved by increasing the orientation degree of the filler in a state prior to thermal expansion. By increasing the orientation degree of the filler before thermal expansion, it is possible to achieve higher stiffness in the desired direction of the thermally expandable sheet with a lower filler content than in cases where the orientation degree of the filler is not controlled. As a result, as already mentioned in the section regarding the filler content in the adhesive layer 20, the wettability of the adhesive layer 20 toward the adherend can be increased as much as possible, which contributes to the adhesive force of the thermally expandable sheet, thereby achieving thermally expandable sheet 1 with high adhesive force. Additionally, since there is no need to include epoxy resins with low softening points in the adhesive layer 20 for the purpose of supplementing the adhesive force of the thermally expandable sheet 1, other effects can be also obtained, such as difficulty in tack development on the adhesive layer 20.

As mentioned above, to control the orientation degree of the filler, the aspect ratio of the filler contained in the adhesive layer 20 is preferably larger than 1 and more preferably 1.5 or more and 80 or less, further preferably 2 or more and 60 or less, and most preferably 3 or more and 40 or less. As the filler, it is possible to use a single type with a uniform aspect ratio, or to use a combination of multiple types with different aspect ratios. When the aspect ratio is small, the thixotropy of the resin composition is less prone to increase, making it easier to mix into the resin composition, which is preferable. On the other hand, when the aspect ratio of the filler is high, even if the shear stress applied when coating the resin composition onto the substrate 10 is low, the orientation degree of the filler increases, and therefore the stiffness of the thermally expandable sheet 1 tends to increase, which is preferable. Note that the aspect ratio referred to herein is the ratio of the length in the long axis direction to the length in the short axis direction of the filler. The aspect ratio can be measured using a scanning electron microscope (SEM). For example, for any 50 particles of filler, a direction of the maximum diameter is defined as the long axis direction, and a length of the long axis direction is measured, and a direction of the minimum diameter is defined as the short axis direction, and a length of the short axis direction is measured. The average values for each are then calculated, and the aspect ratio can be determined by calculating a ratio of the average length of the long axis direction to the average length of the short axis direction (average length in the long axis direction/average length in the short axis direction).

Furthermore, the filler contained in the adhesive layer 20 of this embodiment may preferably have a scale-like, plate-like, needle-like, fibrous, or branched shape, and it is possible to use one or multiple types of fillers having these shapes.

Furthermore, the average of the orientation degree, which is an angle between the long axis direction of the filler and MD direction, as observed by SEM in the thickness direction relative to MD direction of the filler in the adhesive layer 20 prior to thermal expansion, is preferably 400 or less.

The SEM observation shall be performed as follows. An image of the surface of the adhesive layer 20 is captured using a scanning electron microscope (SEM, model SU3800, manufactured by Hitachi High-Tech, Inc.) from the thickness direction of the adhesive layer 20. The observation field and magnification are adjusted so that a sufficient number of filler particles, depending on the particle size of the filler used, can be accommodated within the field of view. Next, the filler section is identified based on differences in contrast using image processing software, and the length along the long axis of the filler is measured. At least 30 particles, or preferably 50 particles, of fillers are selected in order from the longest length along the long axis, and the angle between the long axis and MD direction of the thermally expandable sheet 1 is calculated.

In the thermally expandable sheet 1 of this embodiment, it is preferable that the percentage of fillers having an orientation degree of less than 450 is 55% or more, relative to the filler within the adhesive layer 20 in the state prior to thermal expansion.

It is desirable that the thermally expandable sheet 1 has the shape retention in TD direction higher than the shape retention in MD direction in a state prior to thermal expansion. By using such thermally expandable sheet 1, the sheet can retain its shape even if bent in TD direction and formed to match the shape of the gap. Furthermore, the thermally expandable sheet 1 is less prone to deformation in MD direction and less prone to buckling, resulting in high insertability into the gap and ease of placement.

To increase the orientation degree of the filler in the adhesive layer 20, it is preferable that the adhesive layer 20 contains two or more types of epoxy resins, using a combination of an epoxy resin with a molecular weight of 10,000 or less and one with a molecular weight of 10,000 or more. When using an epoxy resin with a molecular weight of 10,000 or more, the viscosity of the resin composition tends to increase during the formation of the adhesive layer 20 of the thermally expandable sheet 1, and the shear stress applied to the coating surface increases during the coating of the resin composition onto the substrate 10, resulting in a higher orientation degree of the filler within the adhesive layer 20. As a result, the stiffness in MD direction can be effectively improved, achieving thermally expandable sheet 1 with a balance between adhesive force and stiffness even when the amount of fillers added is small. On the other hand, when using an epoxy resin with a molecular weight of 10,000 or less, the viscosity tends to decrease during thermal expansion of the thermally expandable sheet 1, resulting in an excellent wettability to the adherend and a tendency for higher adhesive force.

Note that the term “molecular weight” as used herein refers to a weight-average molecular weight or a calculated molecular weight.

To increase the orientation degree of the filler in the adhesive layer 20, the molecular weight of the elastomer contained in the adhesive layer 20 is preferably 10,000 or more and 1,000,000 or less, more preferably 50,000 or more and 800,000 or less, and even more preferably 100,000 or more and 500,000 or less. By setting the molecular weight of the elastomer to 10,000 or more, the viscosity of the entire resin composition tends to increase during the formation of the adhesive layer 20, and the shear stress applied to the coating surface increases during the coating of the resin composition onto the substrate 10, resulting in a higher orientation degree of the filler within the adhesive layer 20. On the other hand, by setting the molecular weight of the elastomer to 1,000,000 or less, the flowability of the adhesive layer 20 increases during thermal expansion, allowing the adhesive layer 20 to expand sufficiently.

Note that the term “molecular weight” as used herein refers to a weight-average molecular weight or a calculated molecular weight. The molecular weight can be measured by gel permeation chromatography (GPC) or the like.

To increase the orientation degree of the filler in the adhesive layer 20, it is preferable to use a filler with a high oil absorption. In the case of using a filler with high oil absorption, the filler tends to absorb or retain liquid components such as resin components and solvents when mixed into the resin composition, making the viscosity of the entire resin composition higher. Additionally, the shear stress applied to the coating surface increases during the coating of the resin composition onto the substrate 10, resulting in a higher orientation degree of the filler within the adhesive layer 20. The oil absorption of the filler is preferably 50 ml/100 g, more preferably 75 ml/100 g, and even more preferably 100 ml/100 g. On the other hand, it is preferable to set the oil absorption to 300 ml/100 g or less since the filler can be more easily dispersed in the resin composition.

If the primer layer 30 contains a filler, it is desirable that the filler in the layer has a high orientation degree, similar to in the adhesive layer 20. If the orientation degree of the filler in the primer layer 30 is high, the stiffness in MD direction of the thermally expandable sheet 1 becomes higher than the stiffness in TD direction, and therefore the stiffness in the insertion direction becomes higher and the shape retention after bending process becomes improved, resulting in thermally expandable sheet 1 with high insertability into narrow gaps.

### <Method for Producing Thermally Expandable Sheet 1>

The thermally expandable sheet 1 of this embodiment can be produced, for example, using the following procedure and method.

For example, the primer layer 30 can be formed by coating a primer composition for forming the primer layer 30 onto the substrate 10 so that the thickness after drying becomes a desired thickness, and then removing the solvent.

The primer composition can be prepared as a varnish-like or slurry-like material obtained by dissolving or dispersing the aforementioned material used to form the primer layer 30 (e.g., polyester resin) in a suitable solvent.

Examples of coating methods for primer compositions include various roll-to-roll manufacturing methods, in which a roll-form substrate is unrolled at a constant speed while coating, drying, and rewinding are performed as a continuous process, as well as spray coating and dip coating. If the primer layer 30 contains the filler, the method for coating the primer composition is preferably a method that applies shear stress in the longitudinal direction of the substrate 10, i.e., MD direction of the thermally expandable sheet 1, during coating. The coating method that applies shear stress in MD direction is preferably roll coating, transfer roll coating, gravure coating, comma coating, dip coating or the like, and more preferably reverse roll coating, gravure reverse coating, rod coating, blade coating, bar coating, wire bar coating, die coating, lip coating or the like. Furthermore, it is desirable to increase the shear stress in MD direction during coating by, for example, increasing the rotation speed of the roll in the case of roll coating, or increasing the injection speed of the primer composition in the case of die coating. By applying shear stress in MD direction during coating, the orientation degree of the filler in the primer layer 30 increases, thereby enhancing the stiffness in MD direction of the thermally expandable sheet 1 while making it easier to ensure shape retention in TD direction after bending.

The primer composition applied to the surface of the substrate via the method as described above is dried to form the primer layer 30.

The adhesive layer 20 can be formed, for example, by coating a resin composition for forming the adhesive layer 20 onto the primer layer 30 formed by the aforementioned method so that the thickness after drying becomes a desired thickness, and then removing the solvent.

The resin composition can be prepared as a varnish-like or slurry-like material by dissolving or dispersing the material used to form the adhesive layer 20 having the aforementioned composition (e.g., epoxy resin) in a suitable solvent.

The solvent in the resin composition is not particularly limited, and for example, solvents commonly used in the manufacture of adhesives, such as MEK (methyl ethyl ketone), can be widely used. The content of solvent in the resin composition is, for example, 20 mass % or more, and may be 25 mass % or more, or 30 mass % or more, relative to the total mass of the resin composition. By increasing the content of solvent in the resin composition, the viscosity of the resin composition decreases, facilitating the escape of air bubbles during drying and thereby preventing the appearance of the adhesive layer 20 from deteriorating. On the other hand, the content of solvent is, for example, 80 mass % or less, and may be 70 mass % or less, or 60 mass % or less, relative to the total mass of the resin composition. By reducing the content of solvent, the viscosity of the resin composition increases and the shear stress applied to the coating surface increases during the coating of the resin composition onto substrate 10, resulting in a higher orientation degree of the filler within the adhesive layer 20.

The resin composition has a viscosity at 23 °C of, for example, 40 mPa S or more, and it may be 120 mPa S or more, or 170 mPa S or more. By increasing the viscosity of the resin composition, the shear stress applied to the coating surface increases during the coating of the resin composition onto the substrate 10, resulting in a higher orientation degree of the filler within the adhesive layer 20. On the other hand, the viscosity at 23 °C is, for example, 10,000 mPa s or less, and may be 5,000 mPa s or less, or 1,000 mPa s or less. By reducing the viscosity of the resin composition, air bubbles are more easily released during drying, thereby preventing the appearance of the adhesive layer 20 from deteriorating. Viscosity can be determined by measuring it using a single-cylinder rotational viscometer in compliance with JIS Z 8803.

Examples of coating methods for resin compositions include various roll-to-roll manufacturing methods, in which a roll-form substrate is unrolled at a constant speed while coating, drying, and rewinding are performed as a continuous process, as well as spray coating and dip coating. The method for coating the resin composition is preferably a method that applies shear stress in the longitudinal direction of the substrate 10, i.e., MD direction of the thermally expandable sheet 1, during coating. The coating method that applies shear stress in MD direction is preferably roll coating, transfer roll coating, gravure coating, comma coating, dip coating or the like, and more preferably reverse roll coating, gravure reverse coating, rod coating, blade coating, bar coating, wire bar coating, die coating, lip coating or the like. Furthermore, it is desirable to increase the shear stress in MD direction during coating by, for example, increasing the rotation speed of the roll in the case of roll coating, or increasing the injection speed of the resin composition in the case of die coating. For example, when the roll coating is used, it is preferable to set the roll rotation speed to 2 μm/min or more. When the bar coating is used, it is preferable to set the bar travel speed (coating speed) to 2 μm/min or more. However, if the viscosity of the resin composition is high, the coating may be performed at a slower speed than that described above, provided that the orientation degree of the filler can be controlled. By applying shear stress in MD direction during coating, the orientation degree of the filler in the adhesive layer 20 increases, thereby enhancing the stiffness in MD direction of the thermally expandable sheet 1 while making it easier to ensure the shape retention in TD direction after bending.

The adhesive layer 20 is formed by drying the resin composition coated onto the surface of the substrate via methods as described above at a temperature lower than the thermal expansion onset temperature of the foaming agent contained in the adhesive layer, for example, at a temperature of 50 °C or more and 110 °C or less, for a period of 30 seconds or more and 300 seconds or less.

When the primer layer and adhesive layer 20 are to be formed on both surfaces of the substrate 10, it is preferable to first form the primer layer 30a and adhesive layer 20a on one surface of the substrate 10 via the aforementioned method, and then form the primer layer 30b and adhesive layer 20b on the opposite surface of the same substrate via the aforementioned method.

### MODIFIED EMBODIMENTS

The present invention is not limited to the above embodiment.

For example, the thermally expandable sheet 1 of the present invention may not be a sheet with the primer layer 30 and the adhesive layer 20 provided on both surfaces of the substrate 10 and may be a sheet with the primer layer 30 and the adhesive layer 20 provided on only one surface of the substrate 10. Furthermore, the thermally expandable sheet 1 may include additional layers depending on its application, or may have a release paper further laminated to the outermost surface of the thermally expandable sheet 1.

For example, if the thermally expandable sheet 1 according to the present invention includes the primer layer 30 and the adhesive layer 20 on both surfaces of the substrate 10, the method of producing the sheet may comprise forming the primer layers 30a and 30b on both surfaces of the substrate 10, and then forming the adhesive layer 20a on the primer layer 30a and the adhesive layer 20b on the primer layer 30b.

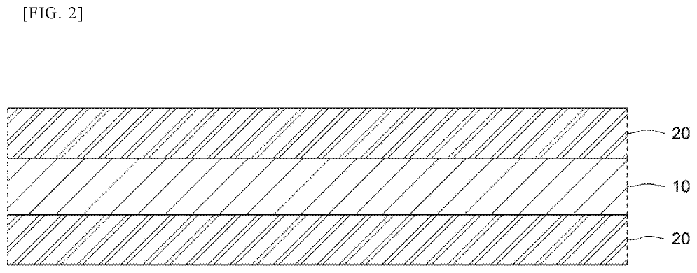

Alternatively, as shown in FIG. 2, the adhesive layer 20 may be laminated directly onto the substrate 10 without providing the primer layer 30, or the adhesive layer 20 may be laminated onto the substrate 10 after subjecting the substrate 10 to corona treatment, primer treatment, or the like to improve an adhesion between the substrate 10 and the adhesive layer 20.

The thermally expandable sheet 1 of the present invention is preferably easily disassembled after use. One method of disassembly may be an approach that degrades the resins contained in the adhesive layer 20 or the primer layer 30, or the substrate 10, thereby reducing the adhesive force. The method for reducing adhesive force is not particularly limited, and may be subjecting the adhered area to high temperature or high humidity for an extended period, boiling the adhered area to chemically reduce the adhesive force, or applying laser irradiation to physically peel it apart.

Thermally expandable sheet 1 can be used for various applications depending on its physical properties, and its uses are not limited to any specific applications. For example, if the sheet is placed in the gap between a coil and a stator core of a motor and used to adhere them together, its thickness prior to thermal expansion is preferably 300 μm or less, and more preferably 20 μm or more and 250 μm or less.

Furthermore, for example, if thermally expandable sheet 1 is used as a conductive sheet for electronic equipment or electronic devices, it preferably has electrical conductivity, and if it is used as an insulating sheet for electronic equipment or electronic devices, it preferably has electrical insulation property.

To place the thermally expandable sheet 1 in the narrow gap formed by multiple adherends and to adhere these multiple adherends together, the thermally expandable sheet 1 after thermal expansion has a shear adhesive force at 23 °C of preferably 0.8 MPa or more, more preferably 0.9 MPa or more, and even more preferably 1.0 MPa or more. The upper limit of the shear adhesive force at 23 °C is not particularly limited, for example, 30 MPa or less, 20 MPa or less, or 10 MPa or less. Furthermore, the shear adhesive force at 200 °C is preferably 0.1 MPa or more, more preferably 0.15 MPa or more, and particularly preferably 0.2 MPa or more. The upper limit of the shear adhesive force at 200 °C is not particularly limited, for example, 10 MPa or less, 7.5 MPa or less, or 5 MPa or less.

Furthermore, if the adherends are, for example, a coil and a stator core of a motor and the thermally expandable sheet 1 is used in a high-temperature environment, the thermally expandable sheet 1 preferably has a shear adhesive force of, for example, 0.1 MPa or more at 200 °C after thermal expansion and further treatment at 200 °C for 500 hours, more preferably 0.15 MPa or more, or further preferably 0.2 MPa or more. The upper limit of the shear adhesive force is not particularly limited, for example, 5 MPa or less, 4 MPa or less, or 3 MPa or less.

If the adherends are, for example, a coil and a stator core of a motor and the thermally expandable sheet 1 is used in a high-temperature environment, the thermally expandable sheet 1 further preferably has a shear adhesive force of, for example, 0.1 MPa or more at 200 °C after thermal expansion and a treatment at 85 °C and 85% RH for 1,000 hours, more preferably 0.15 MPa or more, or further preferably 0.2 MPa or more. The upper limit of the shear adhesive force is not particularly limited, for example, 5 MPa or less, 4 MPa or less, or 3 MPa or less.

The shear adhesive force of thermally expandable sheet 1 is measured by the following method.

The thermally expandable sheet 1 that is cut out in 12.5×25 mm, is fixed to an SPCC plate using a 110 °C rubber roller. Spacers with a thickness of 0.175 mm are placed on both sides of the thermally expandable sheet 1, and another SPCC plate is stacked on top of it, then the gap between the SPCC plates is secured using a fixing jig (such as a clamp). Thermally expandable sheet 1 between SPCC plates is thermally expanded and cured, and the resulting piece is used as a sample. During the process, the gap between the two SPCC plates is maintained at 0.175 mm. The sample, which has been subjected to an arbitrary heat treatment, is tested using a universal testing machine (AGS-10kNX manufactured by Shimadzu Corporation; load cell capacity: 10 kN) under an arbitrary test atmosphere at a test speed of 5 mm/min. Specifically, the two SPCC plates of the sample are pulled in opposite directions along the planar direction of the sample, and the applied pressure at which the sample breaks is measured as the shear adhesive force.

Thermally expandable sheet 1 can be used, for example, as a conductive sheet for electronic equipment or electronic devices if it has electrical conductivity, or as an insulating sheet for electronic equipment or electronic devices if it has electrical insulation property.

Additionally, other variations of the embodiments, as well as combinations of parts of the embodiments, are also permissible as long as they do not conflict with the spirit of the present invention.

### Examples

The following provides a more detailed explanation of the present invention with specific examples. However, the present invention is not limited to these examples.

In this study, thermally expandable sheets were produced according to Examples 1 to 12, and their physical properties were evaluated.

<<Formation of Adhesive Layer 20a>>

Resin compositions were prepared by mixing MEK into formulations G1 to G9 shown in Table 1 below to achieve the solid content indicated in Table 2. Each resin composition was coated onto substrate 10 using a Baker-type applicator so that the thickness after drying was 50 μm. The viscosity of these resin compositions was measured in accordance with JIS Z 8803 using a single-cylinder rotational viscometer (VT-06, manufactured by Rion Corporation) at a temperature of 23 °C and a rotation speed of 62.5 rpm. The results are shown in Table 3.

As substrate 10, a product named Kapton (registered trademark) 100EN manufactured by DuPont-Toray Corporation with a thickness of 25 μm was used. Adhesive layer 20a was formed by drying it at 110 °C for 90 seconds to remove the solvent.

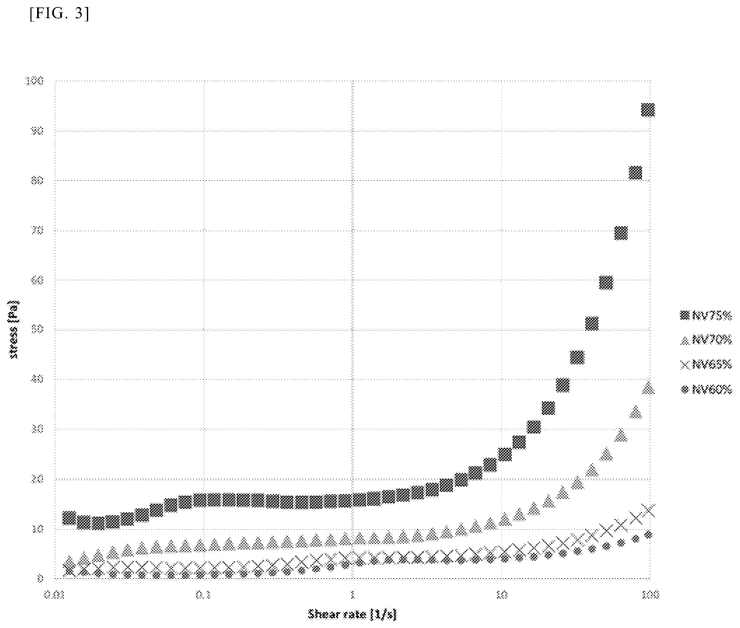

In this example, the shear stress during the coating method for the resin composition used to form the adhesive layer 20a was simulatively measured using the following method. The results are shown in FIG. 3.

### <<Measurement of Shear Stress>>

The evaluation was performed using a rheometer (ARES-G2, manufactured by TA Instruments) with a double-cylinder-type jig consisting of a cup with an inner diameter of 26 mm and a rotor with an outer diameter of 25 mm, by measuring flow curves at 23 °C over a shear rate range of 0.01 to 100/s. The vertical axis of the graph represents shear stress (units: Pa), and the horizontal axis represents shear rate (units: 1/s).

Each resin composition of Example 4 (NV75% in the graph), Example 5 (NV70% in the graph), reference examples with a solid content of 65 mass % (NV65% in the graph) and 60 mass % (NV60% in the graph) having the same composition as Example 5 was put into a cup, and the shear stress was measured while varying shear rate (the rotation speed of the rotor). The shear rate in this experiment can be considered to simulate the coating speed when coating the resin composition along a specific direction.

### <<Evaluation of Shear Stress>>

The results in FIG. 3 show that the shear stress tends to increase as the shear rate (coating speed) increases, regardless of the resin composition used. Consequently, regarding the results of Examples 11 and 12, in which the coating speed was varied, the stress required to orient the filler in the resin composition was sufficiently large under conditions where the shear stress was high, resulting in a high orientation degree of the filler, and therefore, a thermally expandable sheet with different levels of Gurley stiffness in the first and second directions was obtained. Furthermore, from the results in FIG. 3, it was found that, for the same shear rate, the higher the solid content concentration of the resin composition, that is, the higher the viscosity of the resin composition, the higher the shear stress tends to be. Considering the above, the results of Examples 4 and 5, in which the viscosity of resin composition was varied by changing the solid content concentration, and the results of Examples 1, 2, and 3, in which the viscosity of resin composition was varied by changing the amount of elastomer with high molecular weight, showed that under high shear stress conditions, the thermally expandable sheets exhibited a higher orientation degree of the filler and a larger difference in Gurley stiffness between the first and second directions.

TABLE 1

| | | Unit | G1 | G2 | G3 | G4 | G5 | G6 | G7 | G8 | G9 |
|---|---|---|---|---|---|---|---|---|---|---|---|
| Epoxy | A1 | mass | 66.9 | 61.9 | 66.3 | 65.5 | 49.2 | 46.4 | 39.2 | 29.3 | 15.1 |
| resin | | part | | | | | | | | | |
| Curing | B1 | equiv- | 1 | 1 | 1 | 1 | — | — | — | — | — |
| agent | | alent | | | | | | | | | |
| | | ratio | | | | | | | | | |
| | B2 | equiv- | — | — | — | — | 1 | 1 | 1 | 1 | 1 |
| | | alent | | | | | | | | | |
| | | ratio | | | | | | | | | |
| Curing | C1 | mass | 1.11 | 1.03 | 1.10 | 1.09 | — | — | — | — | — |
| accelerator | | part | | | | | | | | | |
| Elastomer | D1 | mass | 0.84 | 0.83 | 0.84 | 0.84 | 9.32 | 9.05 | 8.34 | 7.37 | 7.06 |
| | | part | | | | | | | | | |
| | D2 | mass | — | — | 0.84 | 1.67 | — | — | — | — | — |
| | | part | | | | | | | | | |
| | D3 | mass | — | — | — | — | 4.36 | 4.24 | 3.9 | 3.45 | 2.8 |
| | | part | | | | | | | | | |
| Foaming | E1 | mass | 8.83 | 8.68 | 8.79 | 8.79 | 9.32 | 9.05 | 8.34 | 7.37 | 7.06 |
| agent | | part | | | | | | | | | |
| Filler | F1 | mass | 16.1 | — | 16.0 | 16.0 | — | — | — | — | — |
| | | part | | | | | | | | | |
| | F2 | mass | — | 21.8 | — | — | — | — | — | — | — |
| | | part | | | | | | | | | |
| | F3 | mass | — | — | — | — | 4.91 | 9.55 | 22.0 | 38.9 | 63.1 |
| | | part | | | | | | | | | |

TABLE 2

| | | solid content | Coating speed |
|---|---|---|---|
| | Formulation | concentration (%) | (mm/sec) |
| Example 1 | G1 | 65 | 200 |
| Example 2 | G3 | 65 | 200 |
| Example 3 | G4 | 65 | 200 |
| Example 4 | G2 | 75 | 200 |
| Example 5 | G2 | 70 | 200 |
| Example 6 | G5 | 35 | 50 |
| Example 7 | G6 | 35 | 50 |
| Example 8 | G7 | 35 | 50 |
| Example 9 | G8 | 35 | 50 |
| Example 10 | G9 | 35 | 50 |
| Example 11 | G8 | 25 | 50 |
| Example 12 | G8 | 25 | 200 |

The components listed in Table 1 are as follows.
A: Epoxy resin “EPICLON (registered trademark) N-690”, epoxy equivalent 210 to 240 g/eq, softening point 85 to 95 °C, weight average molecular weight 1,400 to 1,500 (manufactured by DIC Corporation)
B-1: Curing agent “jER Cure (registered trademark) Dicy7”, amine equivalent 21 g/eq (manufactured by Mitsubishi Chemical Corporation)
B-2: Curing agent “Resitop (registered trademark) PSM-4326”, Hydroxyl Equivalent 105 g/eq (manufactured by Gun Ei Chemical Industry Corporation)
C: Curing accelerator “ADEKA Hardener (registered trademark) EH-5046S” (manufactured by ADEKA Corporation)
D-1: Elastomer “S-LEC (registered trademark) KS-6Z” (manufactured by Sekisui Chemical Corporation), glass transition temperature 113 °C, calculated molecular weight 108,000
D-2: Elastomer “Nipol (registered trademark) AR12” (manufactured by Zeon Corporation)
D-3: Elastomer “Vamac (registered trademark) GLS” (manufactured by DuPont Corporation), glass transition temperature −24 °C, weight average molecular weight 280,000
E: Foaming agent “Matsumoto Microsphere (registered trademark) FN-100SSD” (manufactured by Matsumoto Yushi-Seiyaku Corporation), thermal expansion onset temperature 120-130 °C
F-1: Needle-like filler “FTL-100”, aspect ratio 19 (manufactured by Ishihara Sangyo Corporation)
F-2: Scale-like filler “Repcomica S-XF”, aspect ratio 15 (manufactured by Repco Corporation)
F-3: Needle-like filler “WFB15”, aspect ratio 17 (manufactured by Nippon Talc Corporation)
   <<Formation of Adhesive Layer 20b>>

The same resin composition as that used for adhesive layer 20a was coated on a surface of substrate 10 opposite to the surface on which adhesive layer 20a was formed, using a Baker-type applicator, so that the thickness after drying was 50 μm. Adhesive layer 20b was formed by drying it at 110 °C for 90 seconds to remove the solvent.

### <<Evaluation of Thermally Expandable Sheets>>

The thermally expandable sheets produced as described above were subjected to the following evaluation tests.

### <<<Filler Orientation>>>

The orientation degree of the filler was evaluated based on the average of the orientation, which is an angle between the long axis direction of the filler and MD direction when observed by SEM in the thickness direction of the thermally expandable sheet, and the percentage of fillers having an orientation degree of less than 45°, relative to the filler within the observation field.

### <<<Gurley Stiffness>>>

A 25.4 mm×25.4 mm sheet was cut out from the thermally expandable sheet prior to thermal expansion, and this was used as a test specimen. The Gurley stiffness was measured by the following steps in compliance with JIS L 1085. The measurement was conducted with a Gurley-type stiffness tester manufactured by Toyo Seiki Seisaku-sho.

The test specimen clamped to a movable arm was rotated left and right at a specified speed, the lower edge of the thermally expandable sheet 1 came into contact with the pendulum, and then the scale reading was recorded when the lower edge of the thermally expandable sheet 1 detached from the pendulum. The stiffness was calculated from the average of five measurements. For example, when the Gurley stiffness in MD direction is measured, the specimen is clamped so that MD direction of the specimen is parallel to the vertical direction. By moving the specimen left and right in the state that the pendulum is in contact with the lower end of the specimen, the specimen bends in a direction perpendicular to MD direction and pushes the pendulum, and the lower end of the specimen leaves the pendulum at the point where the bending of the specimen reaches its maximum. When the Gurley stiffness in TD direction is measured, the specimen is clamped to the movable arm so that TD direction of the specimen is parallel to the vertical direction, and the measurement is performed based on the same principle. The Gurley stiffness in both MD and TD directions was measured.

Furthermore, based on the Gurley stiffness measured as described above, the direction with higher Gurley stiffness among MD and TD directions in each example was defined as the first direction, and the direction with lower Gurley stiffness was defined as the second direction. The ratio of the Gurley stiffness in the first direction to the Gurley stiffness in the second direction (first/second) was then calculated.

To enhance the stiffness in MD direction and to facilitate bending processes in TD direction of the thermally expandable sheet, it is preferable that MD direction is the first direction and TD direction is the second direction, and that the ratio of the Gurley stiffness in MD direction to the Gurley stiffness in TD direction (MD/TD) is 1.1 or more, more preferably 1.5 or more, and even more preferably 2.0 or more.

### <<<Shape Retention>>>

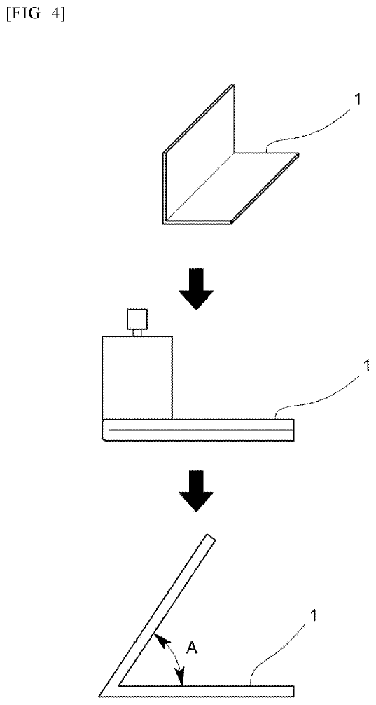

Shape retention was evaluated by the following method. A test specimen with a size of 20 mm×20 mm was cut out from the thermally expandable sheet prior to thermal expansion. As shown in FIG. 4, the specimen was folded by 180° at its center, and a bending process was performed by placing a 200 g weight on the folding line for 5 seconds. Angle A formed by the two ends of the test specimen and the folding line was measured with a protractor at 5 seconds after the weight was removed, and the shape retention was evaluated based on that measurement. When angle A is small, the shape retention of the thermally expandable sheet 1 can be evaluated as high. Note that the bending process was performed such that for evaluating the shape retention in MD direction, the folding line was perpendicular to MD direction, and for evaluating the shape retention in TD direction, the folding line was perpendicular to TD direction.

Additionally, for each example, the direction with higher Gurley stiffness among MD and TD directions in the evaluation of Gurley stiffness described above was defined as the first direction, and the direction with lower Gurley stiffness was defined as the second direction, and the ratio of angle A in the second direction to angle A in the first direction (second/first) was calculated. To enhance the stiffness in MD direction of the thermally expandable sheet and facilitate bending processes in TD direction, it is preferable that MD direction is the first direction and TD direction is the second direction, and that the ratio of angle A in TD direction to angle A in MD direction (TD/MD) is 0.95 or less, more preferably 0.93 or less, and even more preferably 0.91 or less.

### <<<Tackiness Evaluation>>>

Tackiness was evaluated using a tackiness tester (“TAC1000” manufactured by Rhesca). The evaluation test was respectively performed at normal temperature atmosphere (23 °C) with a probe and a stage set to 23 °C, 40 °C, or 60 °C. The thermally expandable sheet 1 prior to thermal expansion was placed on the stage with the surface of the adhesive layer facing upward. The probe with a diameter of 5 mm was pressed against the sample at a pressing speed of 1.0 mm/s and a pressing load of 200 gf, maintained at a load of 10 gf for 1 second, and then pulled up at a pull-up speed of 10.0 mm/s. The peak value (gf) during the pull-up was recorded, and the tack value was calculated using the following formula. Cases where the tack value was 5 gf or less were classified as “OK”.

Tack value (gf)=(peak value measured with the sample placed on the stage)−(peak value measured without the sample placed on the stage)

### <<<Shear Adhesive Force>>>

The thermally expandable sheet prior to thermal expansion that is cut out in 12.5×25 mm, was fixed to an SPCC plate using a 110 °C rubber roller. Spacers with a thickness of 0.175 mm were placed on both sides of the thermally expandable sheet, and another SPCC plate was stacked on top of it, then the gap between the SPCC plates was secured using a fixing jig (such as a clamp). Thermally expandable sheet between SPCC plates was heated to 160 °C at a heating rate of 50 °C/min, held at 160 °C for 5 minutes to allow expansion and curing, and then this was used as a sample for evaluating shear adhesive force. During the process, the gap between the two SPCC plates is maintained at 0.175 mm.

Using a universal testing machine (AGS-10kNX manufactured by Shimadzu Corporation; load cell capacity: 10 kN), the two SPCC plates of the sample for evaluating shear adhesive force were pulled in opposite directions along the planar direction of the sample under the condition of an atmosphere of 200 °C and a test speed of 5 mm/min, and the applied pressure at which the sample broke was taken as the shear adhesive force.

TABLE 3

| | | EX. 1 | EX. 2 | EX. 3 | EX. 4 | EX. 5 | EX. 6 | EX. 7 | EX. 8 | EX. 9 | EX. 10 | EX. 11 | EX. 12 |
|---|---|---|---|---|---|---|---|---|---|---|---|---|---|
| adhesive composition | | G1 | G3 | G4 | G2 | G2 | G5 | G6 | G7 | G8 | G9 | G8 | G8 |
| solid content concentration | | 65 | 65 | 65 | 75 | 70 | 35 | 35 | 35 | 35 | 35 | 25 | 25 |
| viscosity (mPa·s) | | 50 | 80 | 120 | — | — | — | — | — | 420 | — | 40 | 40 |
| Filler Orientation | average orientation | 53.3º | 40.4º | 34.8º | 25.5° | 36.6º | 40.2° | 29.7º | 14.2º | 15.2º | 25.3° | 41.8º | 31.3º |
| | Filler percentage of less than 45º | 42% | 54% | 70% | 88% | 68% | 53% | 76% | 94% | 92% | 88% | 54% | 70% |
| Gurley stiffness | MD (mgf) | 99.3 | 71.9 | 76.0 | 68.4 | 68.1 | 40.1 | 53.5 | 72.9 | 138.39 | 125.5 | 64.1 | 68.5 |
| | TD (mgf) | 102.7 | 65.7 | 63.0 | 60.8 | 61.8 | 36.7 | 40.4 | 43.1 | 59.6 | 52 | 61.2 | 59.9 |
| | First/Second | 1.03 | 1.09 | 1.21 | 1.13 | 1.10 | 1.09 | 1.32 | 1.69 | 2.32 | 2.41 | 1.05 | 1.14 |
| Shape retention | MD (º) | 99.3 | 96.7 | 100 | 95 | 88.3 | 56.7 | 60 | 66.7 | 100 | 90 | 98.3 | 95 |
| | TD (º) | 91.7 | 100 | 95 | 88.3 | 83.3 | 55 | 55 | 58.3 | 81.7 | 85 | 106.7 | 90 |
| | Second/First | 1.02 | 1.03 | 0.95 | 0.93 | 0.94 | 0.97 | 0.92 | 0.87 | 0.82 | 0.94 | 1.09 | 0.95 |
| Tackiness | 23 °C | OK | OK | OK | OK | OK | OK | OK | OK | OK | OK | OK | OK |
| | 40 °C | OK | OK | OK | OK | OK | OK | OK | OK | OK | OK | OK | OK |
| | 60 °C | OK | OK | OK | OK | OK | OK | OK | OK | OK | OK | OK | OK |

| | | | | | | | | | | | | |
|---|---|---|---|---|---|---|---|---|---|---|---|---|
| Shear adhesive force (MPa) | — | — | — | — | — | — | — | 2.7 | 1.8 | 1 | 1.1 | 1.9 |

### DISCUSSION

As shown in Examples 1 to 12 in Table 3, it was possible to produce thermally expandable sheets having adhesive layers made from resin compositions with various types of compositions, wherein the thermally expandable sheets had different levels of Gurley stiffness in different directions from each other of the first direction (e.g., MD direction) and the second direction (e.g., TD direction). According to these thermally expandable sheets, it is possible to achieve high Gurley stiffness in one of the first and second directions while achieving high bendability (shape retention) in the other of the first and second directions.

In particular, Examples 3-5, 7-10, and 12, in which the average of the orientation degree of the filler is 400 or less and the percentage of fillers having an orientation degree of less than 450 is 55% or more, are preferred because the difference in Gurley stiffness between MD and TD directions of the thermally expandable sheet can be made distinct enough to be clearly distinguished by values such as 5 or more, 10 or more, or 20 or more.

Furthermore, from the comparison between Examples 8 and 11, the thermally expandable sheet with an average orientation degree of the filler of 40° or less, or with a percentage of filers having an orientation degree of less than 450 of 55% or more, achieves sufficiently high Gurley stiffness in MD direction even with a low filler content, and enables this value to be significantly higher than the Gurley stiffness in TD direction. As a result, not only strength of stiffness in MD direction and bendability in TD direction, but also higher adhesive force can be achieved simultaneously, which is particularly desirable.

From the results of Examples 3, 4, 7, and 8, the effects of the present invention described above can be seen to be achieved regardless of the filler content or shape. Furthermore, the aspect ratio of the filler is not limited to those mentioned in the examples. As described above, when the aspect ratio is larger than 1, the orientation degree of the filler tends to be easily controlled.

The epoxy resin is not limited to the one used in the Examples and other types may be used as appropriate depending on the required properties, such as adhesive force and tackiness.

Although the Examples herein describe cases in which the elastomer is included, the elastomer is not essential for achieving the effects of the present invention. To enhance the orientation degree of the filler by adjusting the viscosity of the resin composition, as shown in Examples 1 to 12, one having a molecular weight within a suitable range may be used; however, since the viscosity of the resin composition also can be controlled by, for example, changing types of the epoxy resins used in combination, the elastomer is not an essential component in this regard.

In addition, the thermally expandable sheets of Examples 1 to 12 were also tested for insertability. A thermally expandable sheet prior to thermal expansion that is cut out in 30 mm×100 mm, and a commercially available stator core for automobile motors were prepared. The thermally expandable sheet was bent into a U-shape in TD direction to match the slot shape of the stator core, and then the thermally expandable sheet was inserted into the slot along MD direction. In all cases for thermally expandable sheets in Examples 1 to 12, it was possible to insert them into the slot appropriately while maintaining their bent shape. In this way, the thermally expandable sheets of Examples 1 to 12 exhibited excellent insertability.

### INDUSTRIAL APPLICABILITY

The present invention can provide a thermally expandable sheet capable of exhibiting sufficiently high insertability even when inserting the thermally expandable sheet into a gap formed by multiple adherends after a bending process. The thermally expandable sheet of the present invention is useful for electrical equipments. In particular, the adhesive sheet of the present invention is useful as an adhesive sheet for adhering coils to the slots of stator cores or rotor cores in rotating electrical machines, such as motors for electric vehicles and hybrid vehicles, and generators.

### REFERENCE SIGNS LIST

1 thermally expandable sheet
10 substrate
20a, 20b adhesive layers
30a, 30b primer layers

1. A thermally expandable sheet for adhering multiple adherends together through thermal expansion, where it is placed between the adherends, wherein
the thermally expandable sheet comprises a substrate having a thickness of 1 to 200 μm and an adhesive layer having a thickness of 10 to 200 μm laminated onto at least one surface of the substrate,
the substrate is a single substrate of a resin film, a nonwoven fabric or a metal film, or a laminate having a laminated structure in which a resin film, a nonwoven fabric or a metal film are adhered together,
the resin film is a film of polyester resins, polycarbonate, polyarylate, polyurethane, polyamide resins, polyimide resins, polysulfone resins, polyetherketone resins, polyphenylene sulfide, or modified polyphenylene oxide,
the nonwoven is a nonwoven comprising cellulose fibers, polyester fibers, nylon fibers, aramid fibers, polyphenylene sulfide fibers, liquid crystal polymer fibers, glass fibers, metal fibers, or carbon fibers, or is a mica paper,
the metal film is a copper foil or an aluminum foil,
the adhesive layer comprises a filler, an epoxy resin, and a curing agent, and
the thermally expandable sheet has a ratio of a Gurley stiffness in MD direction of the thermally expandable sheet to a Gurley stiffness in TD direction of the thermally expandable sheet (MD direction/TD direction) of 1.1 or more.

2. A thermally expandable sheet for adhering multiple adherends together through thermal expansion, where it is placed between the adherends, wherein
the thermally expandable sheet comprises a substrate having a thickness of 1 to 200 μm and an adhesive layer having a thickness of 10 to 200 μm laminated onto at least one surface of the substrate,
the substrate is a single substrate of a resin film, a nonwoven fabric or a metal film, or a laminate having a laminated structure in which a resin film, a nonwoven fabric or a metal film are adhered together,
the resin film is a film of polyester resins, polycarbonate, polyarylate, polyurethane, polyamide resins, polyimide resins, polysulfone resins, polyetherketone resins, polyphenylene sulfide, or modified polyphenylene oxide,
the nonwoven is a nonwoven comprising cellulose fibers, polyester fibers, nylon fibers, aramid fibers, polyphenylene sulfide fibers, liquid crystal polymer fibers, glass fibers, metal fibers, or carbon fibers, or is a mica paper,
the metal film is a copper foil or an aluminum foil,
the adhesive layer comprises a filler, an epoxy resin, and a curing agent,
the filler comprises a filler with a scale-like, plate-like, needle-like, fibrous, or branched shape, and
the thermally expandable sheet prior to thermal expansion has an average of orientation degree of the filler of 400 or less:
wherein the orientation degree of the filler for the thermally expandable sheet prior to thermal expansion is defined as an angle between the long axis direction of the filler and MD direction of the thermally expandable sheet, as observed by SEM in the thickness direction of the thermally expandable sheet.

3. A thermally expandable sheet for adhering multiple adherends together through thermal expansion, where it is placed between the adherends, wherein
the thermally expandable sheet comprises a substrate having a thickness of 1 to 200 μm and an adhesive layer having a thickness of 10 to 200 μm laminated onto at least one surface of the substrate,
the substrate is a single substrate of a resin film, a nonwoven fabric or a metal film, or a laminate having a laminated structure in which a resin film, a nonwoven fabric or a metal film are adhered together,
the resin film is a film of polyester resins, polycarbonate, polyarylate, polyurethane, polyamide resins, polyimide resins, polysulfone resins, polyetherketone resins, polyphenylene sulfide, or modified polyphenylene oxide,
the nonwoven is a nonwoven comprising cellulose fibers, polyester fibers, nylon fibers, aramid fibers, polyphenylene sulfide fibers, liquid crystal polymer fibers, glass fibers, metal fibers, or carbon fibers, or is a mica paper,
the metal film is a copper foil or an aluminum foil,
The adhesive layer comprises a filler, an epoxy resin, and a curing agent,
the filler comprises a filler with a scale-like, plate-like, needle-like, fibrous, or branched shape, and
the thermally expandable sheet prior to thermal expansion has a percentage in total filler of fillers having an orientation degree of less than 450 of 55% or more:
wherein the orientation degree of the filler for the thermally expandable sheet prior to thermal expansion is defined as an angle between the long axis direction of the filler and MD direction of the thermally expandable sheet, as observed by SEM in the thickness direction of the thermally expandable sheet.

4. A thermally expandable sheet for adhering multiple adherends together through thermal expansion, where it is placed between the adherends, wherein
the thermally expandable sheet comprises a substrate having a thickness of 1 to 200 μm and an adhesive layer having a thickness of 10 to 200 μm laminated onto at least one surface of the substrate,
the substrate is a single substrate of a resin film, a nonwoven fabric or a metal film, or a laminate having a laminated structure in which a resin film, a nonwoven fabric or a metal film are adhered together,
the resin film is a film of polyester resins, polycarbonate, polyarylate, polyurethane, polyamide resins, polyimide resins, polysulfone resins, polyetherketone resins, polyphenylene sulfide, or modified polyphenylene oxide,
the nonwoven is a nonwoven comprising cellulose fibers, polyester fibers, nylon fibers, aramid fibers, polyphenylene sulfide fibers, liquid crystal polymer fibers, glass fibers, metal fibers, or carbon fibers, or is a mica paper,
the metal film is a copper foil or an aluminum foil,
the adhesive layer comprises a filler, an epoxy resin, a curing agent, and an elastomer,
the elastomer comprises an elastomer having a glass transition temperature (Tg) of 100 °C or more and an elastomer having Tg of less than 100 °C, and
the thermally expandable sheet prior to thermal expansion has a Gurley stiffness in MD direction of the thermally expandable sheet larger than a Gurley stiffness in TD direction of the thermally expandable sheet.

5. The thermally expandable sheet according to claim 1, wherein the adhesive layer is an adhesive layer formed by using a resin composition comprising components that constitute the adhesive layer and a solvent and having a solid content concentration of 25 to 75%.

6. The thermally expandable sheet according to claim 1, wherein a Gurley stiffness in MD direction of the thermally expandable sheet is 53.5 mgf or more.

7. The thermally expandable sheet according to claim 1, wherein the filler comprises a filler having an aspect ratio of 1.5 or more and 80 or less.

8. The thermally expandable sheet according to claim 1, wherein the content of the filler is 5 mass % or more and less than 80 mass % relative to 100 mass % of the adhesive layer.

9. The thermally expandable sheet according to claim 1, wherein the epoxy resin comprises an epoxy resin having a softening point of 60 °C or more.

10. The thermally expandable sheet according to claim 1, wherein the epoxy resin comprises an epoxy resin having an epoxy equivalent of less than 300.

11. The thermally expandable sheet according to claim 1, wherein the adhesive layer comprises two or more epoxy resins, and at least one epoxy resin has a molecular weight of 10,000 or more.

12. The thermally expandable sheet according to claim 4, wherein the elastomer comprises an elastomer having a molecular weight of 100,000 or more.

13. The thermally expandable sheet according to claim 1, wherein the thermally expandable sheet prior to thermal expansion has a shape retention in TD direction higher than a shape retention in MD direction.

14. The thermally expandable sheet according to claim 1, having a coefficient of dynamic friction on its surface prior to thermal expansion of 0.6 or less.

15. The thermally expandable sheet according to claim 1, having a shear adhesive force after thermal expansion and curing of 0.8 MPa or more at 23 °C and 0.1 MPa or more when heated to 200 °C.

16. An article provided with the thermally expandable sheet according to claim 1.

17. The article according to claim 16, wherein the article is a motor.
